(19) United States
(12) Patent Application Publication
(10) Pub. No.: US 2006/0205412 A1
(43) Pub. Date: Sep. 14, 2006

(54) System and method for controlling resource allocation in a multicell communication system

(75) Inventors: Seong-Keun Oh, Suwon-si (KR); Ki-Bum Kwon, Seongnam-si (KR)

Correspondence Address: DILWORTH & BARRESE, LLP, 333 EARLE OVINGTON BLVD., UNIONDALE, NY, 11553, US

(73) Assignees: Samsung Electronics Co., Ltd., Suwon-si (KR); Seoul National University Industry Foundation, Seoul (KR)

(21) Appl. No.: 11/371,966

(22) Filed: Mar. 9, 2006

(30) Foreign Application Priority Data
Mar. 9, 2005 (KR) 2005-19790

(51) Int. Cl. H04Q 7/20

(52) U.S. Cl. 455/450; 455/509

(57) ABSTRACT

A method is provided for controlling resource allocation in a multicell communication system including a plurality of cells, each of the cells using the same frequency band. The method comprises dividing the frequency band for each of the cells into a plurality of band groups; dividing a cell region for each of the cells into a plurality of segment regions; and mapping corresponding segment regions to each of the band groups.

### PRIORITY

This application claims the benefit under 35 U.S.C. § 119(a) of an application filed in the Korean Intellectual Property Office on Mar. 9, 2005 and assigned Serial No. 2005-19790, the entire contents of which are incorporated herein by reference.

### BACKGROUND OF THE INVENTION

1. Field of the Invention

The present invention relates generally to a multicell communication system, and in particular, to a system and method for controlling resource allocation to minimize inter-cell interference (ICI) and maximize frequency resource efficiency.

2. Description of the Related Art

Multicell communication systems suffers from ICI because multiple cells that make up the multicell communication system are required to use limited resources, for example frequency resources, code resources and time slot resources, on a division basis, and some different cells reuse the same resources. However, the multiple cells use the frequency resources on a division basis, even though the multicell communication system suffers from performance degradation due to the ICI, in order to increase its total capacity.

A description will now be made of a frequency reuse factor K.

In order to reuse frequency resources with reduced ICI in the multicell communication system in which multiple cells are provided and the cells use a frequency band on a division basis, the frequency band is divided into K sub-frequency bands, where K denotes the frequency reuse factor. The K sub-frequency bands are allocated to K cells including a serving cell among the multiple cells, and the K sub-frequency bands are reused in some of the remaining cells except for the K cells, taking into account the interference to or from other cells.

As the frequency reuse factor exceeds 1 (K>1), ICI decreases but the amount of frequency resources available in one cell also decreases, causing a reduction in the total capacity of the multicell communication system. On the contrary, if the frequency reuse factor is 1 (K=1), i.e., if all cells constituting the multicell communication system use the same frequency band, ICI increases but the amount of frequency resources available in one cell also increases, causing an increase in the total capacity of the multicell communication system.

However, because setting the frequency reuse factor K to 1 (K=1), taking into account the total capacity of the multicell communication system, increases the ICI as described above, there have been proposed various ICI control schemes for preventing performance degradation due to the ICI while decreasing the frequency reuse factor. The ICI control schemes are roughly classified into an ICI averaging scheme for averaging the ICI and an ICI avoidance scheme for avoiding the ICI. The ICI averaging scheme is used when there is difficulty in acquiring feedback information for ICI avoidance control in such a channel environment that frequently varies with the passage of time, or when there is difficulty in achieving ICI avoidance control because of the system architecture. The ICI avoidance scheme is used when there is a need to maximize frequency resource efficiency by minimizing the ICI in despite of the system loss such as an increase in the complexity.

The ICI control schemes such as the ICI averaging scheme and the ICI avoidance scheme are generally applied in a cell application strategy design phase and a transmission scheme design phase. A typical ICI control scheme applied in the cell application strategy design phase includes a frequency reuse partitioning scheme. With reference to FIG. 1, a description will now be made of the frequency reuse partitioning scheme.

FIG. 1 is a diagram illustrating a method for allocating frequency resources using a frequency reuse partitioning scheme in a general multicell communication system.

Before a description of FIG. 1 is given, it should be noted that the frequency reuse partitioning scheme has been proposed to minimize the ICI while setting an actual frequency reuse factor \tilde{K} to 1 (\tilde{K}=1) for allocation of frequency resources. In FIG. 1, the frequency reuse partitioning scheme divides a corresponding cell into a total of M clusters such that the circular or hexagonal clusters having different radii from the cell center do not overleap each other.

After dividing the corresponding cell into a total of M clusters, the frequency reuse partitioning scheme allocates a partial frequency band (hereinafter referred to as a “sub-band”) of the frequency band allocated to the corresponding cell, to each of the M clusters. The sub-bands allocated to the M clusters are different from each other. The frequency reuse partitioning scheme allows a sub-band allocated to a particular cluster of the corresponding cell to be reused in a cell spaced apart from the corresponding cell by at least a distance D that is defined as a negligible value by minimizing an ICI effect defined for each of the M clusters. Herein, the reuse distance D for the reuse of the frequency resource can be expressed as

$$D = \frac{{R}_{1}}{{Q}_{1}} = \frac{{R}_{2}}{{Q}_{2}} = \frac{{R}_{3}}{{Q}_{3}} ⋯ = \frac{{R}_{M}}{{Q}_{M}} \qquad ( 1 )$$

In Equation (1), R₁, R₂, R₃, . . . R_{M} denote radii of the clusters existing in the cell center up to the cell boundary of the corresponding cell, and Q₁, Q₂, Q₃, . . . , Q_{M} denote center distances between the corresponding cell and the cells where the clusters are reused in the case where the clusters existing in the cell center up to the cell boundary of the corresponding cell are reused in the cells other than the corresponding cell.

However, the frequency reuse partitioning scheme has many restrictions in reusing the frequency band in a corresponding cluster because it needs to always set a constant factor, i.e., a constant reuse distance D, according to a radius of the corresponding cluster for reuse of the corresponding frequency band, for each of the M clusters.

In order to increase the frequency reuse efficiency of the frequency reuse partitioning scheme, there has been proposed a Dynamic Channel Assignment (DCA) scheme for dynamically allocating frequency resources for every cluster by removing the restriction on the size of the frequency band used for each cluster. The DCA scheme contributes to a noticeable increase in the frequency resource efficiency.

However, the DCA scheme also has a limitation in improving its performance due to the restrictions on the frequency reuse, because it is based on the frequency reuse partitioning scheme, i.e., satisfies the basic frequency reuse condition of the frequency reuse partitioning scheme. Accordingly, there is a need for a resource allocation control scheme for improving the frequency resource efficiency while minimizing the ICI.

### SUMMARY OF THE INVENTION

It is, therefore, an object of the present invention to provide a system and method for controlling resource allocation to minimize inter-cell interference (ICI) in a multicell communication system.

It is another object of the present invention to provide a system and method for controlling resource allocation to maximize frequency resource efficiency in a multicell communication system.

According to one aspect of the present invention, there is provided a system for controlling resource allocation in a multicell communication system including a plurality of cells, each of the cells using the same frequency band. The system includes a controller for dividing a cell region for each of the cells into a plurality of segment regions, dividing the frequency band for each of the cells into a plurality of band groups, mapping corresponding segment regions to each of the band groups, and upon detecting user data targeting a plurality of mobile stations (MSs), allocating a band group through which the user data for each of the MSs will be transmitted, among the plurality of band groups; a band group allocator for allocating a band group such that the user data for each of the MSs is transmitted through the corresponding band group; a bandwidth allocator for allocating a bandwidth of the band group allocated for transmission of the user data for each of the MSs; a load factor allocator for allocating a load factor of the band group allocated for transmission of the user data for each of the MSs; a power allocator for allocating power of the band group allocated for transmission of the user data for each of the MSs; and a radio frequency (RF) processor for RF-processing a signal of the power-allocated band group and transmitting the RF-processed signal.

According to another aspect of the present invention, there is provided a method for controlling resource allocation in a multicell communication system including a plurality of cells, each of the cells using the same frequency band. The method includes dividing the frequency band for each of the cells into a plurality of band groups; dividing a cell region for each of the cells into a plurality of segment regions; and mapping corresponding segment regions to each of the band groups.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a method for allocating frequency resources using a frequency reuse partitioning scheme in a general multicell communication system;

FIG. 2 is a diagram illustrating an operation of dividing band groups using a consecutive division technique in a multicell communication system according to the present invention;

FIG. 3 is a diagram illustrating an operation of dividing band groups using an non-consecutive division technique in a multicell communication system according to the present invention;

FIGS. 4A to 4D are diagrams illustrating an operation of determining bandwidths of band groups in a multicell communication system according to the present invention;

FIG. 5 is a diagram illustrating an operation of setting band groups using a consecutive sub-carrier allocation technique in a multi-carrier multicell communication system according to the present invention;

FIG. 6 is a diagram illustrating an operation of setting band groups using an non-consecutive sub-carrier allocation technique in a multi-carrier multicell communication system according to the present invention;

FIGS. 7A to 7G are diagrams illustrating an operation of dividing segment regions of a cell region in a multicell communication system according to the present invention;

FIG. 8 is a diagram illustrating an operation of mapping segment regions to a band group in a multicell communication system according to the present invention;

FIGS. 9A to 9D are diagrams illustrating an operation of determining a load factor for each individual band group in a multicell communication system according to the present invention;

FIGS. 10A to 10D are diagrams illustrating an operation of determining power density of each individual band group in a multicell communication system according to the present invention;

FIG. 11 is a diagram illustrating an operation of dividing segment regions during design of a multicell communication system according to the present invention;

FIG. 12 is a diagram illustrating interference between segment regions mapped to the same band groups in neighbor cells during design of a multicell communication system according to the present invention;

FIG. 13 is a diagram illustrating an operation of determining bandwidth and load factor for each individual band group during design of a multicell communication system in which power density is uniform according to the present invention;

FIG. 14 is a block diagram illustrating a structure of a downlink transmitter according to the present invention; and

FIG. 15 is a block diagram illustrating a structure of an uplink transmitter according to the present invention.

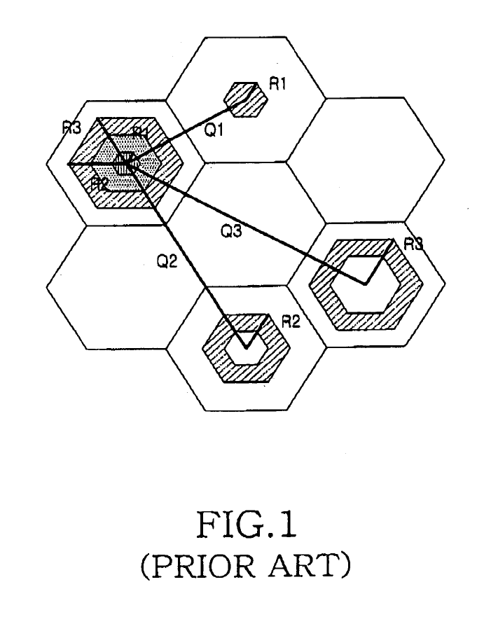

### DETAILED DESCRIPTION OF PREFERRED EMBODIMENTS

Preferred embodiments of the present invention will now be described in detail with reference to the annexed drawings. In the following description, a detailed description of known functions and configurations incorporated herein has been omitted for clarity and conciseness.

The present invention provides a system and method for controlling resource allocation to maximize frequency resource efficiency while minimizing inter-cell interference (ICI) in a multicell communication system. In particular, the present invention provides a resource allocation control system and method for minimizing ICI while maximizing the frequency resource efficiency by allocating the frequency resources according to regional characteristics in each cell in a multicell communication system with a frequency reuse factor of K=1.

For convenience, it will be assumed herein that a controller of each cell will control the allocating of the frequency resources in the multicell communication system, and the controller allocates the frequency resources taking into account the frequency resources of the cells constituting the multicell communication system.

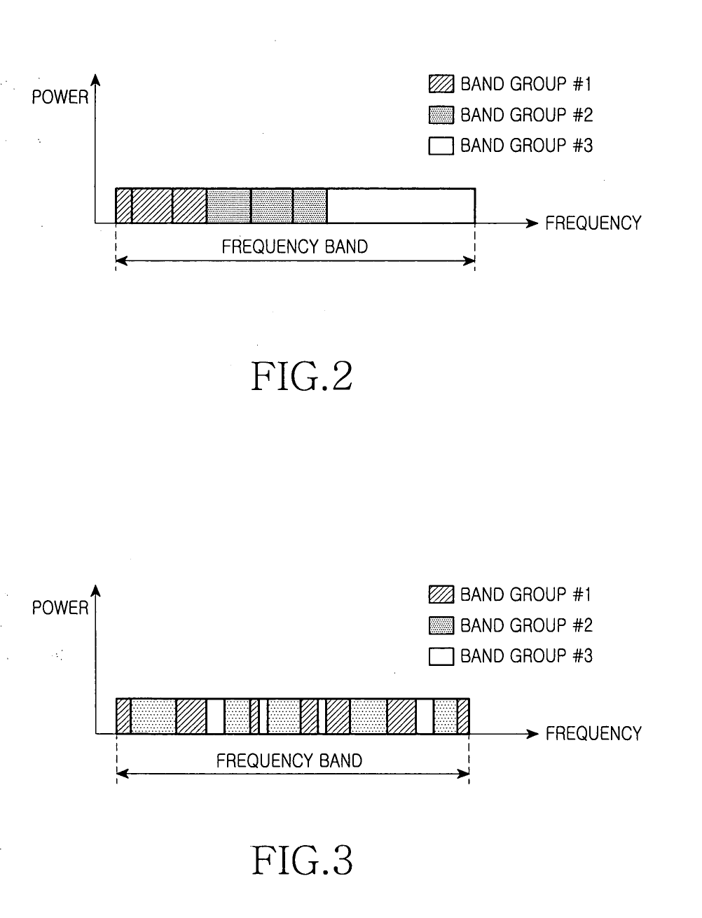

FIG. 2 is a diagram illustrating an operation of dividing band groups using a consecutive division technique in a multicell communication system according to the present invention.

Referring to FIG. 2, an embodiment of the present invention divides the frequency band used in each cell of the multicell communication system into a plurality of band groups. For example, in FIG. 2, the frequency band is divided into 3 band groups using the consecutive division technique. That is, a controller, as it uses the consecutive division technique, divides the frequency band of the corresponding cell into 3 physically consecutive band groups of a first band group, a second band group and a third band group. Herein, each of the band groups is mapped such that it is allocated to at least one or more segment regions.

FIG. 3 is a diagram illustrating an operation of dividing band groups using an non-consecutive division technique in a multicell communication system according to the present invention.

Referring to FIG. 3, a frequency band is divided into 3 band groups on an non-consecutive basis. That is, a controller, as it uses the non-consecutive division technique, divides the frequency band of the corresponding cell into 3 physically non-consecutive band groups of a first band group, a second band group and a third band group. Similarly, each of the band groups is mapped such that it is allocated to at least one or more segments.

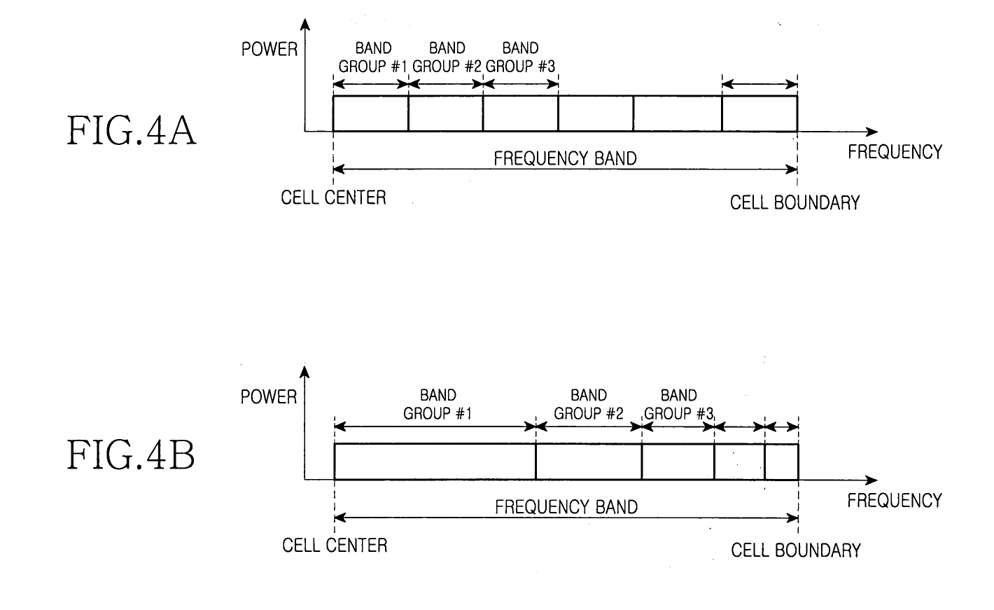

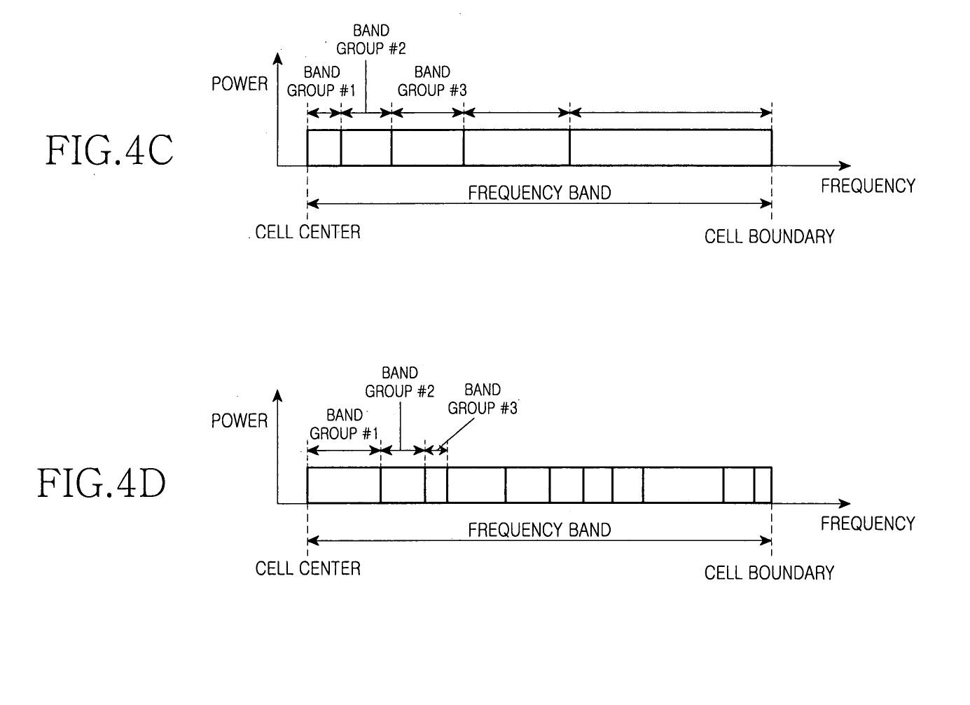

FIGS. 4A to 4D are diagrams illustrating an operation of determining bandwidths of band groups in a multicell communication system according to the present invention.

As illustrated in FIG. 4A, bandwidths of the band groups are determined such that the bandwidths of all band groups are equal to each other. Alternatively, as shown in FIGS. 4B to 4D, bandwidths of the band groups are determined such that the bandwidths of all band groups are different taking into account such conditions as size, load factor, power density, geographical condition, channel condition, interference condition, user distribution, and data rate of a segment region applied to each band group. Herein, the conditions used for determining the bandwidth of each band group may include various other conditions in addition to the foregoing conditions. In the exemplary case of FIG. 4B, the bandwidths of the band groups are allocated in such a manner that the broadest bandwidth is allocated to segment regions in the cell center and the narrowest bandwidth is allocated to segment regions in the cell boundary. In the exemplary case of FIG. 4C, the bandwidths of the band groups are allocated in such a manner that the narrowest bandwidth is allocated to the segment regions in the cell center and the broadest bandwidth is allocated to the segment regions in the cell boundary. In the exemplary case of FIG. 4D, the bandwidth of each band group is determined independently according to the requirements of the corresponding band group.

Communication systems using multiple orthogonal sub-carriers with the same bandwidth, such as a communication system employing an Orthogonal Frequency Division Multiplexing (OFDM) scheme (OFDM communication system), a communication system employing an Orthogonal Frequency Division Multiple Access (OFDMA) scheme (OFDMA communication system), and a communication system employing a Multi Carrier-Code Division Multiple Access (MC-CDMA) scheme (MC-CDMA communication system), can be used in dividing the frequency band into band groups. Such communication systems as the OFDM communication system, the OFDMA communication system, and the MC-CDMA communication system will be referred to a “multi-carrier multicell communication system.” The multi-carrier multicell communication system can define at least one or more physically consecutive sub-carriers as one band group, or define at least one or more physically non-consecutive sub-carriers as one band group.

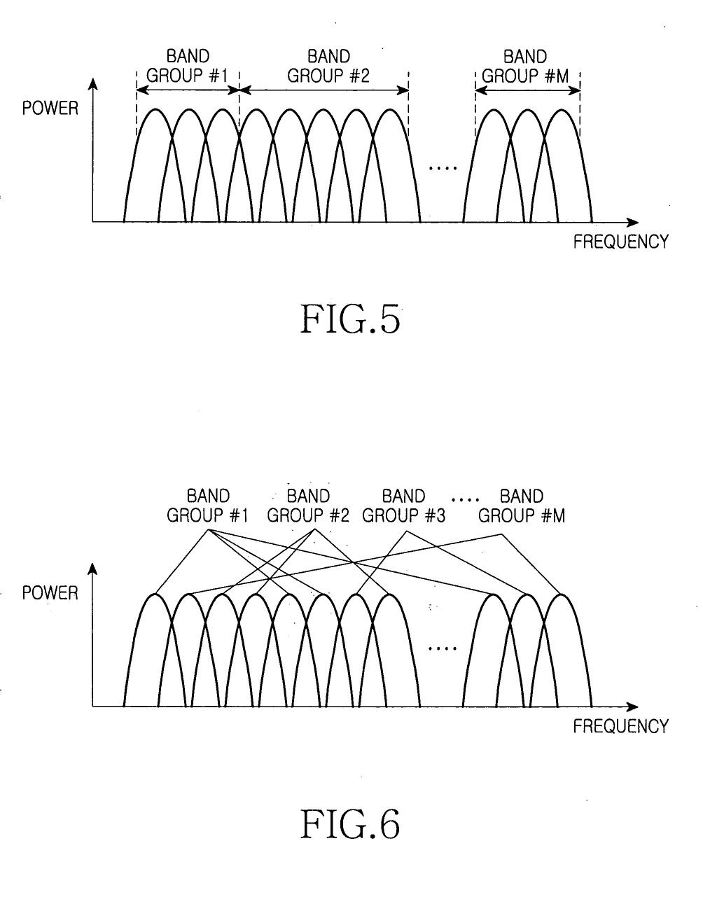

With reference to FIG. 5, a description will now be made of an operation of defining at least one or more physically consecutive sub-carriers as one band group.

FIG. 5 is a diagram illustrating an operation of setting band groups using a consecutive sub-carrier allocation technique in a multi-carrier multicell communication system according to the present invention.

In FIG. 5, there are shown a plurality of band groups, for example a total of M band groups of first to M^{th} band groups, each of which includes a plurality of physically consecutive sub-carriers.

FIG. 6 is a diagram illustrating an operation of setting band groups using an non-consecutive sub-carrier allocation technique in a multi-carrier multicell communication system according to the present invention.

In FIG. 6, there are shown a plurality of band groups, for example a total of M band groups of first to M^{th} band groups, each of which includes a plurality of physically non-consecutive sub-carriers.

The foregoing rule of dividing a frequency band for each cell into band groups can be applied in the same way to every cell constituting the multicell communication system to minimize ICI.

The present invention divides a cell region for each of the cells constituting the multicell communication system into a plurality of segment regions taking into account various conditions for ICI reduction, and maps the segment regions such that they are allocated a frequency band for each band group according to a predetermined rule. Further, in order to increase the frequency resource efficiency of the corresponding band group for each of the band groups mapped to the segment regions, the embodiment of the present invention controls bandwidth, load factor and power density for each of the band groups according to the cell application strategy and the system design criterion for each of the cells constituting the multicell communication system.

A description will now be made of a scheme for allocating resources for each individual band group through division of band groups and division of segment regions for each cell region before transmission to increase the frequency resource efficiency.

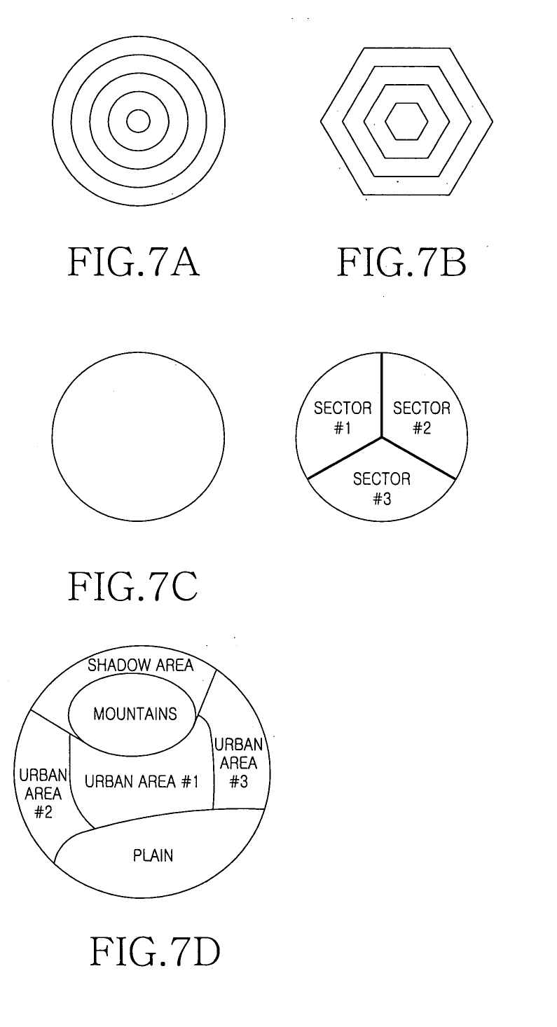

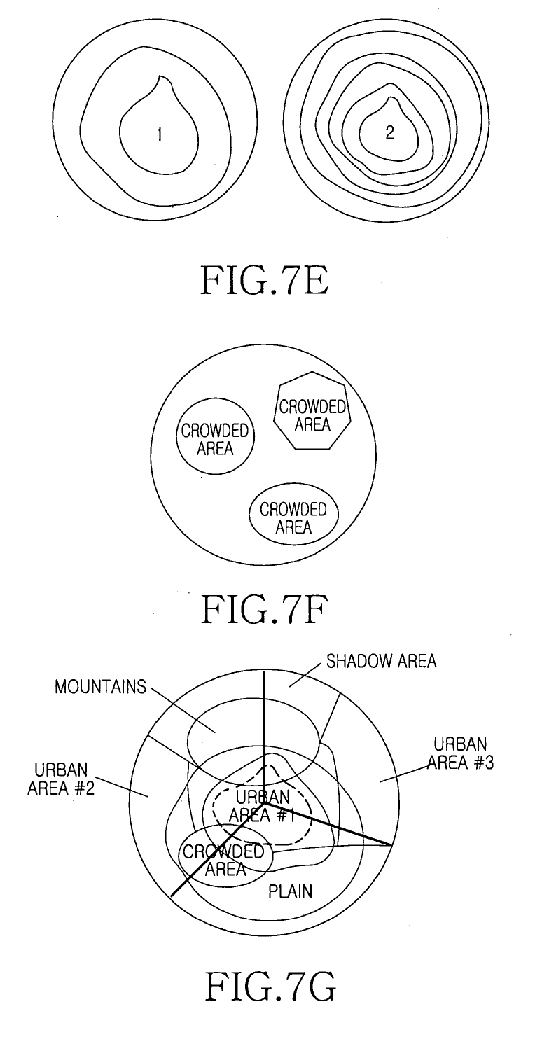

FIGS. 7A to 7G are diagram illustrating an operation of dividing segment regions of a cell region in a multicell communication system according to the present invention.

In the exemplary case of FIG. 7A, a cell region is divided into a plurality of circular segment regions at the cell center. In the exemplary case of FIG. 7B, a cell region is divided into a plurality of hexagonal segment regions at the cell center.

In the exemplary case of FIG. 7C, a cell region is divided into a plurality of segment regions taking antenna characteristics into account. Herein, the antenna characteristics are determined depending on radiation patterns, positions, and radiation angles of transmission/reception antennas of a base station (BS) and a mobile station (MS). Specifically, in FIG. 7C, the cell region is divided into a plurality of segment regions taking, for example, the radiation angles, into account. That is, FIG. 7C illustrates a case where the cell region is divided into a plurality of segment regions for the omni-directional radiation and another case where the cell region is divided into a plurality of segment regions for the directional radiation. In the latter case, the cell region is divided into 3 segment regions of first to third segment regions.

In the exemplary case of FIG. 7D, a cell region is divided into a plurality of segment regions taking into account geographical conditions. Herein, the geographical conditions are determined depending on the position where the MS in the cell region is located. Specifically, in FIG. 7D, the cell region is divided into a plurality of segment regions according to whether the position of the MS is a shadow area, a mountain area, a plain area, or an urban area.

In the exemplary case of FIG. 7E, a cell region is divided into a plurality of segment regions taking into account channel conditions and interference conditions. Herein, the channel conditions are determined depending on signal level attenuation caused by a change in distance, shadow effect, fading effect, multipath effect, and Doppler effect. The interference conditions are determined based on user distribution of a corresponding cell, user distributions of other cells, Signal-to-Interference and Noise Ratio (SINR) based on channel characteristics, and outage rate. Specifically, in FIG. 7E, the cell region is divided into a plurality of segment regions taking the SINR into consideration. In particular, FIG. 7E illustrates a case where the cell region is divided into a plurality of segment regions when there are a greater number of criteria for determining the SINR, and another case where cell region is divided into a plurality of segment regions when there are a less number of criteria for determining the SINR.

In the exemplary case of FIG. 7F, a cell region is divided into a plurality of segment regions taking into account user distribution conditions. Herein, the user distribution conditions are determined depending on high population area (or crowded area) and uniform distribution area. Specifically, in FIG. 7F, the cell region is divided into a plurality of segment regions taking into account, for example, the high population area,.

In the exemplary case of FIG. 7G, a cell region is divided into a plurality of segment regions taking complex conditions into account. Specifically, in FIG. 7G, the cell region is divided into a plurality of segment regions taking, for example, the user distribution and geographical conditions, into account on a complex basis.

As described above, the present invention divides a cell region into a plurality of segment regions taking into account antenna characteristics, geographical conditions, channel conditions, interference conditions, and user distribution conditions. In addition, when some resource parameters such as bandwidth, load factor, and power density for each individual band group are determined before the cell region is divided into a plurality of segment regions, the embodiment of the present invention can also divide the cell region into a plurality of segment regions taking into account the predetermined resource parameters along with the antenna characteristics, geographical conditions, channel conditions, interference conditions and user distribution determined according to the design criterion and application strategy of the multicell communication system. Herein, the application strategy of the multicell communication system can include a strategy for providing uniform service opportunity to every user in the cell or a strategy for maximizing transmission efficiency in the cell.

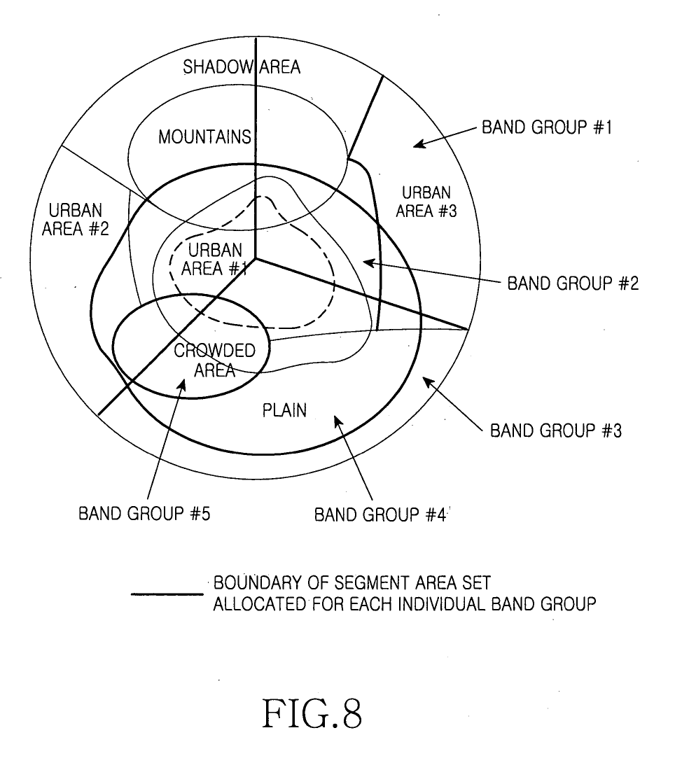

FIG. 8 is a diagram illustrating an operation of mapping segment regions to a band group in a multicell communication system according to the present invention.

As illustrated in FIG. 8, the cell region is divided into a plurality of segment regions, and each of the segment regions is mapped to its associated band group.

The present invention can also determine the segment regions mapped to each individual band group according to the system design condition and application strategy, taking into account signal conditions, interference conditions and user distribution between the same band groups in the segment regions mapped to the same group in the cells neighboring a corresponding cell of the multicell communication system. That is, when some resource parameters such as bandwidth for each individual band group, load factor, and power density are determined before the cell region is divided into a plurality of segment regions, the present invention can also divide the cell region into segment regions such that the conditions required by each band group are satisfied according to the determined resource parameters and the system design criterion and application strategy of the multicell communication system and the segment regions are mapped to each of the band groups.

In allocating resources to maximize resource efficiency, the multicell communication system should take the foregoing various conditions into account, and should first take the bandwidth of each band group into consideration. As described above, each of the band groups is mapped to at least one or more segment regions, and a bandwidth for each of the band groups is determined taking into account the size of a segment region or segment region group, load factor, power density, geographical conditions, channel conditions, interference conditions, user distribution, transmission scheme, and data rate. In particular and as primary factors, the bandwidth of each band group should be determined taking into account the segment region mapped to the band group or the size of the segment region group. Although the bandwidth of each band group differs according to the system design criterion and application strategy, it is a general rule that as the bandwidth is set broader, as the size of the segment region mapped to the band group is larger, the load factor available in the band group is lower, the power density is lower, the shadow area like the mountain area is broader, the interference level is higher, the user density is higher, and the data rate is higher. On the contrary, as the bandwidth is set narrower, as the size of the segment region mapped to the band group is smaller, the load factor available in the band group is higher, the power density is higher, the shadow area is narrower, the interference level is lower, the user density is lower, and the data rate is lower.

Of course, the bandwidths of all band groups may be set equal to each other as described with reference to FIG. 4A. However, assuming that the bandwidth is determined according to the size of the segment region mapped to each band group and that the size of the segment region closer to the cell center is smaller and the size of the segment region closer to the cell boundary is larger, the bandwidth of the band group mapped to the segment regions in the cell center is set narrowest and the bandwidth of the band group mapped to the segment regions in the cell boundary is set broadest as described with reference to FIG. 4C. On the contrary, if the size of the segment region closer to the cell boundary is smaller and the size of the segment region closer to the cell center is larger, the bandwidth of the band group mapped to the segment regions in the cell center is set broadest and the bandwidth of the band group mapped to the segment regions in the cell boundary is set narrowest as described with reference to FIG. 4B.

However, in the general multicell communication system, because the geographical conditions, channel conditions, interference conditions, user distribution and data rate are not constant in the cell region, the bandwidths of the band groups are set according to the requirements in the segment regions mapped to each band group as described with reference to FIG. 4D.

The important parameters used in setting the load factor for each individual band group include the size of segment regions or segment region groups mapped to each band group, user distribution, bandwidth, power density, geographical conditions, channel conditions, interference conditions, transmission scheme, and data rate. Although the load factor of the band group differ according to the system design criterion and application strategy, it is a general rule that as the load factor is set higher, as the size of the segment region mapped to the band group is larger, the bandwidth is narrower, the power density is higher, the channel conditions are better, the geographical conditions provide a narrower shadow area, the interference power is lower, and the data rate is higher. On the contrary, as the load factor of the band group is set lower, as the size of the segment region mapped to the band group is smaller, the bandwidth is broader, the power density is lower, the channel conditions are worse, the geographical conditions provide a broader shadow area, the interference power is higher, and the data rate is lower.

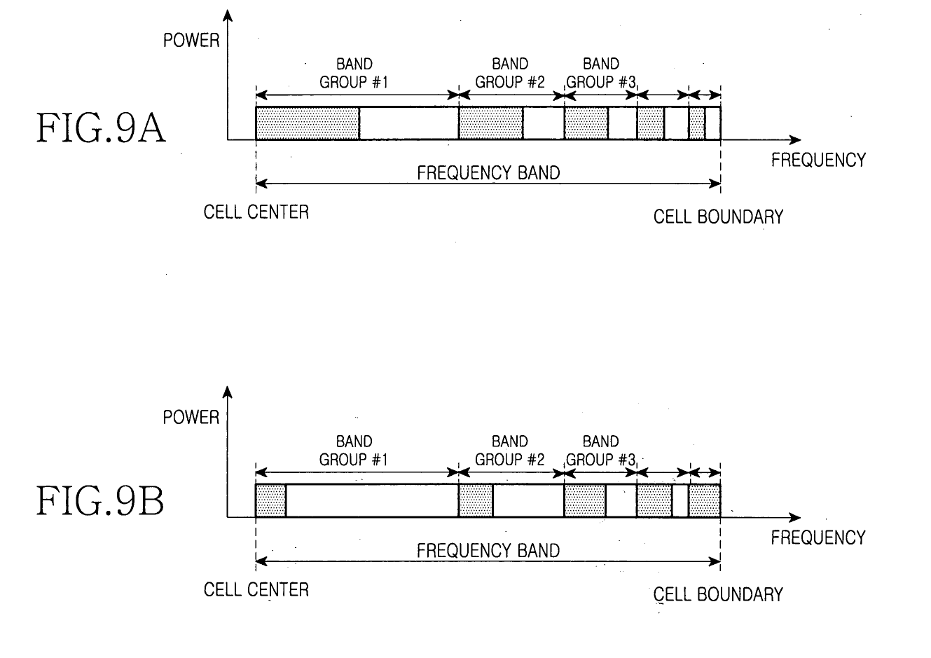

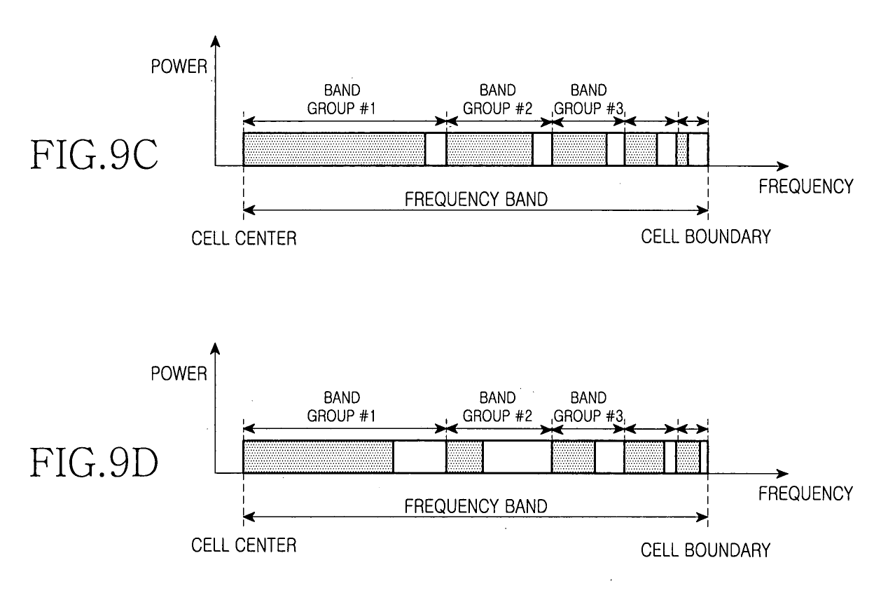

With the use of the foregoing scheme, it is possible to independently determine a load factor of each band group. With reference to FIGS. 9A to 9D, a description will now be made of an exemplary operation of setting a load factor of each band group when the bandwidth of the band group mapped to the segment region in the cell center is set broadest and the bandwidth of the band group mapped to the segment region in the cell boundary is set narrowest as described with reference to FIG. 4B.

FIGS. 9A to 9D are diagrams illustrating an operation of determining a load factor for each individual band group in a multicell communication system according to the present invention.

In the exemplary case of FIG. 9A, the same load factor is determined for every band group. In the exemplary case of FIG. 9B, the load factor of the band group mapped to the segment region in the cell boundary is set higher than that of the load factor of the band group mapped to the segment region in the cell center. In the exemplary case of FIG. 9C, the load factor of the band group mapped to the segment region in the cell center is set higher than that of the load factor of the band group mapped to the segment region in the cell boundary. In the exemplary case of FIG. 9D, the load factor of a band group is determined according to the requirements of the segment regions mapped to the corresponding band group.

In FIGS. 9B and 9C, the load factor of each band group is determined according to the interference conditions and bandwidths when the geographical conditions, user distribution and data rate are constant in the cell region. That is, as illustrated in FIG. 9C, the segment regions closer to the cell center have a higher load factor for the band group mapped thereto, because they have lower interference power and broader bandwidths, and the segment regions closer to the cell boundary have a lower load factor for the band group mapped thereto, because they have higher interference power and narrower bandwidths. In the opposite case, the load factor of each band group is determined as shown in FIG. 9B.

However, it is a general rule that the load factor of each band group is determined according to the requirements in the segment regions mapped to each band group as illustrated in FIG. 9D, because the geographical conditions, channel conditions, interference conditions, user distribution and data rate in the cell region are not constant.

The parameters affecting the process of determining the power density for each individual band group include the size of segment regions or segment region groups mapped to each band group, bandwidth, load factor, user distribution, geographical conditions, channel conditions, interference conditions, transmission scheme, and data rate. Although the power density for each band group differs according to the system design criterion and application strategy of the multicell communication system, it is a general rule that as the power density is set higher, as the size of the segment region mapped to the band group is larger, the bandwidth is broader, the load factor is higher, the channel conditions are worse, the interference level is higher, the geographical conditions provide a broader shadow area like the mountain area, and the data rate is higher. On the contrary, as the power density of the band group is set lower, as the size of the segment region mapped to the band group is smaller, the bandwidth is narrower, the load factor is lower, the channel conditions are better, the interference level is lower, the geographical conditions provide a narrower shadow area, and the data rate is lower.

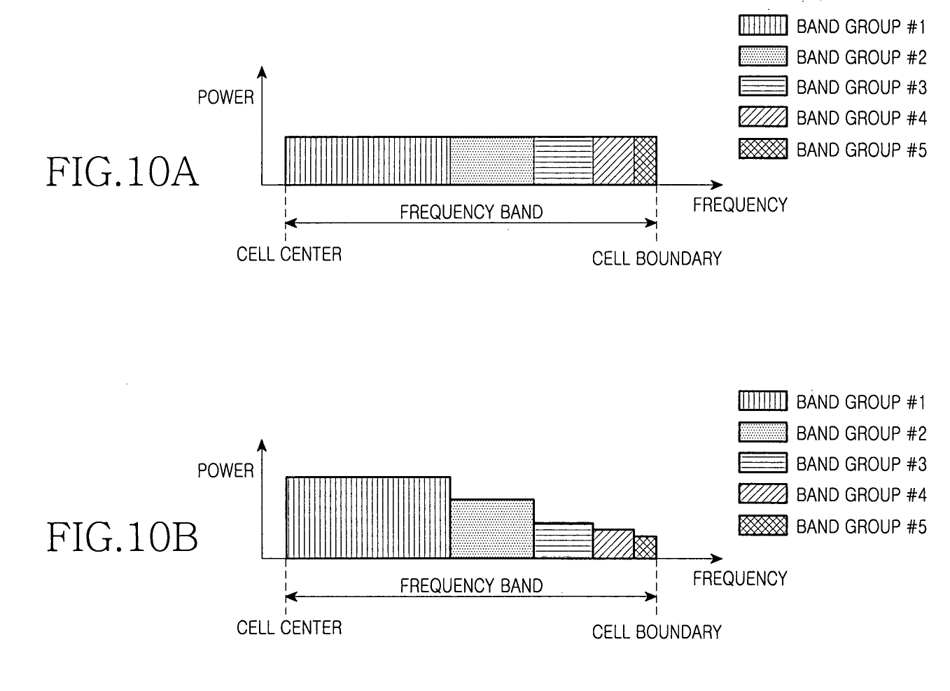

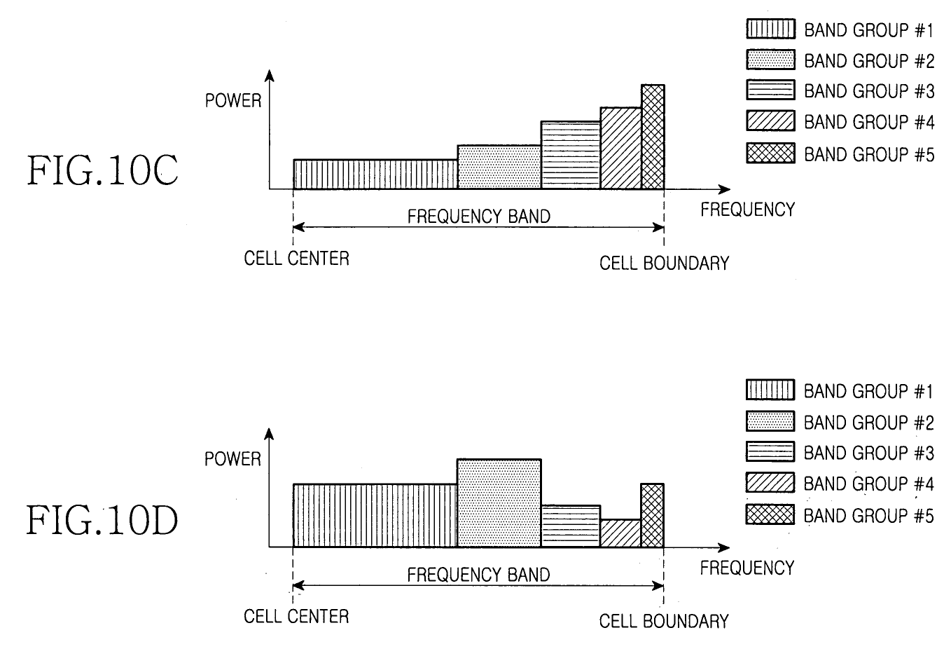

Therefore, the present invention determines the power density for each individual band group according to the system design criterion and application strategy of the multicell communication system, taking into account the influence of the parameters. In addition, this embodiment should first determine a power control range for each individual band group before determining the power density for each individual band group. With reference to FIGS. 10A to 10D, a description will now be made of an operation of determining power density of each band group when the bandwidth for each individual band group is determined as described with reference to FIG. 4B, i.e., when the bandwidth of a band group mapped to the segment regions in the cell center is set broader than that of the bandwidth of a band group mapped to the segment regions in the cell boundary.

FIGS. 10A to 10D are diagrams illustrating an operation of determining power density of each individual band group in a multicell communication system according to the present invention.

In the exemplary case of FIG. 10A, the power density is uniformly determined for each individual band group. In the exemplary case of FIG. 10B, the power density of a band group mapped to the segment regions in the cell center is set higher than that of the power density of a band group mapped to the segment region in the cell boundary. In the exemplary case of FIG. 10C, the power density of a band group mapped to the segment regions in the cell boundary is set higher than that of the power density of a band group mapped to the segment region in the cell center. In the exemplary case of FIG. 10D, the power density of each band group is determined according to the requirements of the segment regions mapped to the band group.

In FIG. 10B, assuming that the multicell communication system maximizes the transmission efficiency in the cell in the application strategy, this embodiment of the present invention sets the power density of the band group mapped to the segment regions in the cell center to be higher than the power density of the band group mapped to the segment regions in the cell boundary to allocate many resources to the users in the cell center where the channel conditions are relatively excellent and the interference is lower.

In FIG. 10C, assuming that the multicell communication system provides uniform service to the users in the cell in the application strategy, this embodiment of the present invention sets the power density of the band group mapped to the segment regions in the cell boundary to be higher than the power density of the band group mapped to the segment regions in the cell center.

Generally, however, because there are numerous system design criteria and application strategies for the multicell communication system and the geographical conditions, channel conditions, interference conditions, user distribution and data rate in the cell region are not constant, the power density of each band group is determined according to the requirements in the segment regions mapped to the band group as illustrated in FIG. 10D.

A description will now be made of an operation of determining the bandwidth, load factor, and power density for each individual band group.

The bandwidth, load factor, and power density for each individual band group are simultaneously determined taking into account the system parameters such as the size of the segment regions mapped to each individual band group, geographical conditions, channel conditions, interference conditions, user distribution, transmission scheme, and data rate.

In the case of simultaneously determining only some of the resource parameters of the bandwidth, the load factor and the power density for each individual band group instead of simultaneously determining all of the bandwidth, the load factor and the power density for each individual band group, only some of the resource parameters of the bandwidth, the load factor and the power density for each individual band group are determined taking into account not only the system parameters such as the size of segment regions, geographical conditions, channel conditions, interference conditions, user distribution, transmission scheme and data rate, but also the remaining resource parameters except for the simultaneously determined resource parameters, as the fixed system parameters. For example, in the case of simultaneously determining only the load factor and power density for each band group instead of simultaneously determining the bandwidth, load factor and power density for each individual band group, the bandwidth for each individual band group is considered as the fixed system parameter.

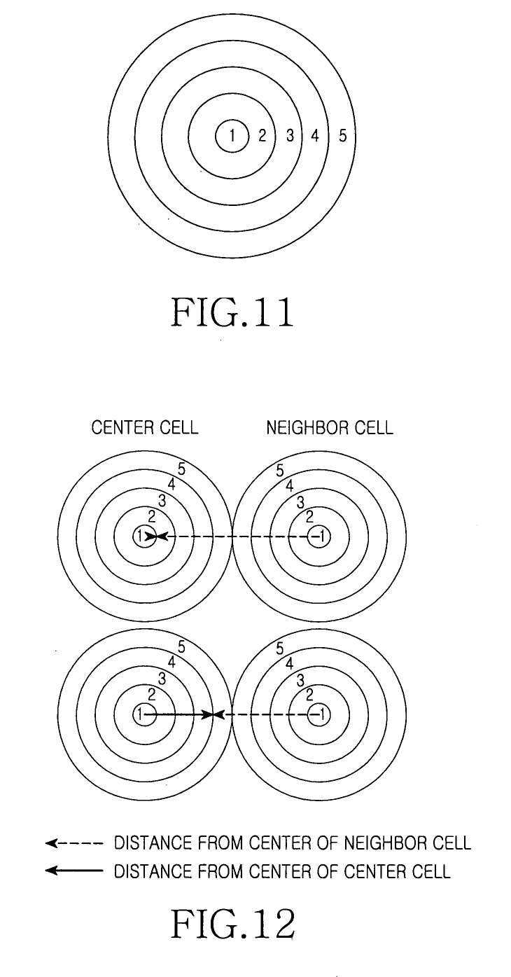

With reference to FIGS. 11 to 13, a description will now be made of an operation of designing an actual multicell communication system taking into account the band group division and segmentation region allocation operations described above.

FIG. 11 is a diagram illustrating an operation of dividing segment regions during design of a multicell communication system according to the present invention.

Before a description of FIG. 11 is given, it will be assumed that each cell of the multicell communication system designed according to the present invention divides its frequency band into a plurality of band groups, the number of which is equal to the number of segment regions of the corresponding cell. Referring to FIG. 11, a cell region of the corresponding cell is divided into a total of 5 circular segment regions centered about the cell center. Numerals shown in FIG. 11 denote band groups to which their associated segment regions are mapped. That is, the segment regions are mapped in such a manner that the segment region in the cell center is mapped to a first band group and the segment region in the cell boundary is mapped to a fifth band group.

FIG. 12 is a diagram illustrating interference between segment regions mapped to the same band groups in neighbor cells during design of a multicell communication system according to the present invention.

In will be assumed in FIG. 12 that in all cells constituting the multicell communication system, the band groups and segment regions are divided in the same manner and the same segment regions are mapped to the same band groups. In this case, a first band group, to which the segment region in the cell center is mapped, is not greatly affected by interference from neighbor cells, because the neighbor cells are spaced apart from each other by a relatively long distance. As a result, it is possible to transmit signals at higher power density and set a higher load factor.

In this way, by controlling the bandwidth, load factor and power density of a band group taking into account the size of the segment region mapped to each individual band group, geographical conditions, channel conditions, interference conditions, user distribution, transmission scheme and data rate, it is possible to design a cellular communication system in various ways, suitable to meet the system design criterion and requirements for the multicell communication system.

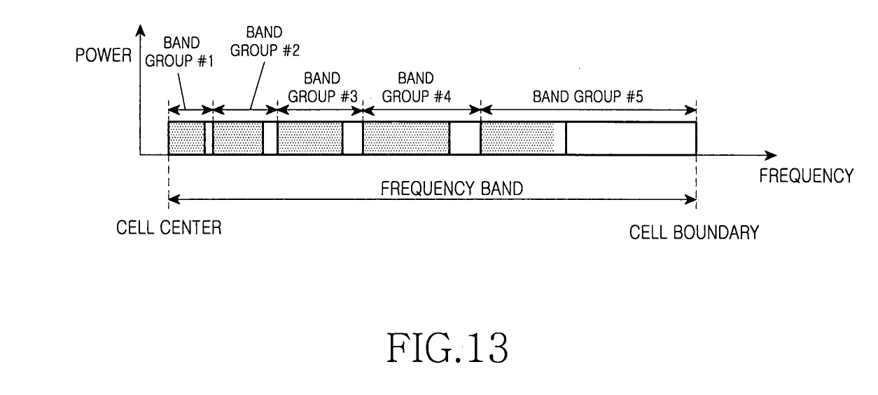

It is possible to determine the bandwidth and load factor for each individual band group in the manner of FIG. 13, even in the case where the multicell communication system applies the system design condition and application strategy in which user distribution in the cell region is uniform and all users in the cell region receive the same service.

FIG. 13 is a diagram illustrating an operation of determining bandwidth and load factor for each individual band group during design of a multicell communication system in which power density is uniform according to an embodiment of the present invention.

If it is assumed as illustrated in FIG. 13 that the power density for each individual band group is uniform, the bandwidth and load factor for each individual band group greatly differ according to the segment region mapped to each band group. That is, a first band group, to which the segment region in the cell center is mapped, has a narrow bandwidth but has a high load factor, because the segment region mapped to the first band group has a small size and low interference. On the contrary, a fifth band group, to which the segment region in the cell boundary is mapped, has a low load factor, because the segment region has high interference. However, the segment region mapped to the fifth band group, because of its large size, should accommodate many users and has a broad bandwidth to cope with the low load factor. Therefore, it can be noted that the valid bandwidth gets broader as the segment region goes from the cell center to the cell boundary.

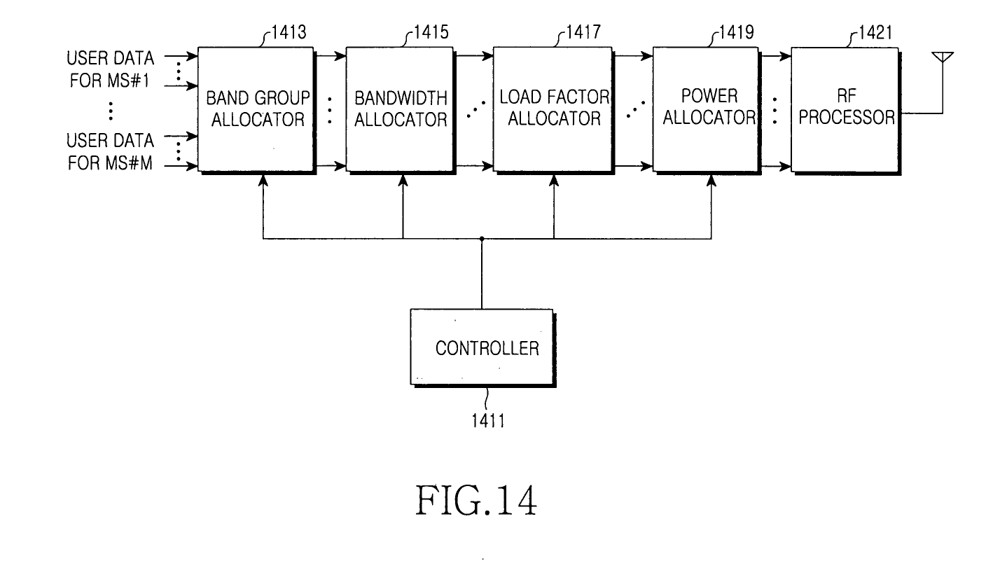

FIG. 14 is a block diagram illustrating a structure of a downlink transmitter according to the present invention.

Referring to FIG. 14, a downlink transmitter, for example, a base station (BS) transmitter, includes a controller 1411, a band group allocator 1413, a bandwidth allocator 1415, a load factor allocator 1417, a power allocator 1419, and a radio frequency (RF) processor 1421.

If user data targeting each of M mobile stations (MSs) is received, the controller 1411 performs scrambling on the user data for each of the M MSs and then controls the scheduled user data for each of the M MSs such that it is allocated a corresponding transmission band group in the band group allocator 1413. When performing scheduling on the user data for each of the M MSs, the controller 1411 performs a control operation such that the band group is allocated taking into account the system design condition and the segment region of the multicell communication system. That is, the controller 1411 controls band group allocation and segment region allocation so as to maximize the system capacity of the multicell communication system or provide the service corresponding to the cell application strategy for each cell of the multicell communication system taking into account the information on user data for all MSs in the cell region, such as channel conditions, interference conditions and data rate, and cell characteristic information such as the size of segment regions in the cell region, geographical conditions, user distribution and transmission scheme. In addition, the controller 1411 allocates not only the bandwidth but also the load factor and power density for each individual band group. Under the control of the controller 1411, the user data for each of the M MSs is allocated a band group, and the bandwidth, load factor and power density for the corresponding band group are determined. The determined information is provided to corresponding elements, i.e., the band group allocator 1413, the bandwidth allocator 1415, the load factor allocator 1417, and the power allocator 1419. The operation, performed by the controller 1411, of allocating the band groups, allocating the segment regions, and allocating the bandwidth, load factor and power density for each individual band group has been described above, so a detailed description there of will be omitted herein. Although the transmitter of FIG. 14 allocates the resources in order of the band group, bandwidth, load factor, and power density, the allocation order of the resources is subject to change.

The band group allocator 1413, under the control of the controller 1411, allocates a corresponding band group to the user data for each of the M MSs, and outputs the allocation results to the bandwidth allocator 1415. A bandwidth allocation operation of the bandwidth allocator 1415 is also controlled by the controller 1411, and the allocation result is output to the load factor allocator 1417. Then the load factor allocator 1417, under the control of the controller 1411, allocates a load factor of each band group, and outputs the load factor allocation result to the power allocator 1419. A power allocation operation of the power allocator 1419 is also controlled by the controller 1411, and the controller 1411 determines the power density for each individual band group and determines transmission power of each band group according to the determined power density.

The power allocator 1419, under the control of the controller 1411, allocates transmission power for each individual band group, and outputs the power allocation result to the RF processor 1421. The RF processor 1421 modulates and codes the user data for each of the M MSs, output from the power allocator 1419, according to predetermined modulation and coding schemes, RF-processes the modulated coded user data, and transmits the RF-processing results over the air via a transmission antenna. The RF processor 1421, which includes a modulator, an encoder, a filter and a front-end unit, modulates and codes the user data for each of the M MSs, output from the power allocator 1419, RF-processes the modulated coded user data such that it can be transmitted over the air, and then transmits the RF-processed user data via the antenna.

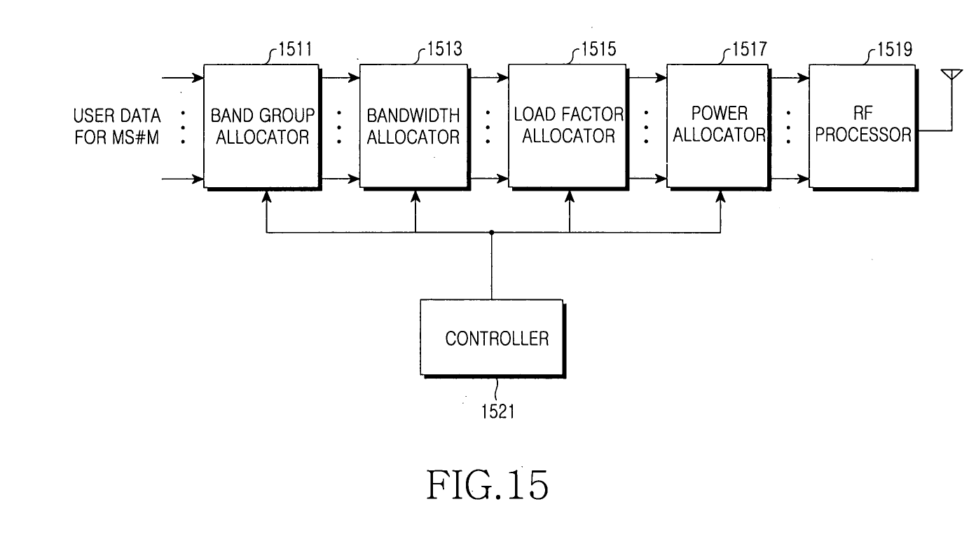

FIG. 15 is a block diagram illustrating a structure of an uplink transmitter according to the present invention.

Referring to FIG. 15, an uplink transmitter, for example, an MS transmitter, includes a band group allocator 1511, a bandwidth allocator 1513, a load factor allocator 1515, a power allocator 1517, an RF processor 1519, and a controller 1521.

Upon detecting the presence of user data to be transmitted from the MS to a BS through an uplink, the controller 1521 controls operations of the band group allocator 1511, the bandwidth allocator 1513, the load factor allocator 1515, and the power allocator 1517 such that the BS transmitter applies the band groups, bandwidth, load factor and transmission power allocated through scheduling of user data for the MS, so as to transmit the user data. The MS receives, from the BS, information on the band groups, bandwidth, load factor and transmission power allocated through the scheduling of the user data for the MS before transmitting the user data, and an operation of transmitting/receiving this information is not directly related to the present invention, so a detailed description thereof will be omitted herein. In addition, operations of the band group allocator 1511, the bandwidth allocator 1513, the load factor allocator 1515, the power allocator 1517 and the RF processor 1519 are substantially similar to the operations of the band group allocator 1413, the bandwidth allocator 1415, the load factor allocator 1417, the power allocator 1419 and the RF processor 1421 of the downlink transmitter, i.e., the BS transmitter, described with reference to FIG. 14, except for the number of MSs applied thereto, so a detailed description thereof will be omitted herein.

As can be understood from the foregoing description, the present invention applies an actual frequency reuse factor \tilde{K}=1 in the multicell communication system to control the bandwidth, load factor and power density of each band group according to regional characteristics of each cell while maximizing efficiency of frequency resources, thereby preventing system performance degradation due to the ICI. In addition, the present invention increases flexibility of frequency resource allocation by allocating frequency resources of the multicell communication system taking into account the load factor and the power density as well.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for controlling resource allocation in a multicell communication system including a plurality of cells, each of the cells using the same frequency band, the method comprising:
dividing the frequency band for each of cells into a plurality of band groups;
dividing a cell region for each of the cells into a plurality of segment regions; and
mapping corresponding segment regions to each of the band groups.

2. The method of claim 1, wherein the mapping of the corresponding segment regions is based on at least one of a size of segment regions mapped to each of the band groups, a position where a mobile station (MS) is located, a geographical condition, a channel condition, an interference condition, and user distribution.

3. The method of claim 1, wherein the mapping of the corresponding segment regions is based on at least one of a signal condition, an interference condition and a user distribution between the same band groups in the segment regions mapped to the same band groups in neighbor cells.

4. The method of claim 1, wherein the cell region dividing is based on at least one of a distance from the cell center, an antenna characteristic applied to each of the cells, a geographical condition for each of the cells, a channel condition and an interference condition for each of the cells, and user distribution condition for each of the cells.

5. The method of claim 4, wherein the antenna characteristic is determined taking into account at least one of a radiation pattern of a transceiver antenna, a location of a transmission/reception antenna, and a radiation angle.

6. The method of claim 4, wherein the channel condition is determined taking into account at least one of a signal level attenuation caused by a change in distance, a shadow effect, a fading effect, a multipath effect, and a Doppler effect, and the interference condition is determined taking into account at least one of user distribution of a corresponding cell, user distribution of another cell, a signal-to-interference and noise ratio (SINR), and an outage rate.

7. The method of claim 1, wherein the frequency band dividing step comprises the step of dividing the frequency band for each of the cells into a plurality of band groups such that segment regions mapped to the plurality of band groups are consecutive.

8. The method of claim 1, wherein the frequency band dividing step comprises the step of dividing the frequency band for each of the cells into a plurality of band groups such that segment regions mapped to the plurality of band groups are non-consecutive.

9. The method of claim 1, wherein if the multicell communication system is a multi-carrier multicell communication system using a plurality of sub-carriers, the frequency band dividing step comprises the step of dividing the frequency band for each of the cells into a plurality of band groups such that sub-carriers mapped to the plurality of band groups are consecutive.

10. The method of claim 1, wherein if the multicell communication system is a multi-carrier multicell communication system using a plurality of sub-carriers, the frequency band dividing step comprises the step of dividing the frequency band for each of the cells into a plurality of band groups such that sub-carriers mapped to the plurality of band groups are non-consecutive.

11. The method of claim 1, wherein the frequency band dividing step comprises the step of dividing the frequency band for each of the cells into a plurality of band groups having the same bandwidth.

12. The method of claim 1, wherein the frequency band dividing step comprises the step of dividing the frequency band for each of the cells into a plurality of band groups having different bandwidths.

13. The method of claim 12, wherein the dividing of the frequency band for each of the cells into a plurality of band groups having is performed according to characteristics of segment regions mapped to each of the plurality of band groups.

14. The method of claim 13, wherein the dividing the frequency band for each of the cells into a plurality of band groups having the different bandwidths takes into account at least one of a size of segment regions mapped to each of the band groups, a load factor applied to each of the band groups, a power density, a geographical condition, a channel condition, an interference condition, user distribution, a transmission scheme, and a data rate.

15. The method of claim 1, further comprising, after dividing the frequency band for each of the cells into a plurality of band groups, determining a load factor for each of the band groups.

16. The method of claim 15, wherein t a uniform load factor is determined for each of the band groups.

17. The method of claim 15, wherein a different load factor is determined for each of the band groups according to characteristics of segment regions mapped to each of the plurality of band groups.

18. The method of claim 17, wherein the determining a different load factor for each of the band groups according to characteristics of segment regions mapped to each of the plurality of band groups takes into account at least one of a size of segment regions mapped to each of the band groups, a bandwidth for each of the band groups, a power density, a geographical condition, a channel condition, an interference condition, user distribution, a transmission scheme, and a data rate.

19. The method of claim 1, further comprising, after dividing the frequency band for each of the cells into a plurality of band groups, determining a power density for each of the band groups.

20. The method of claim 19, wherein a uniform power density is determined for each of the band groups.

21. The method of claim 19, wherein a different power density is determined for each of the band groups according to characteristics of segment regions mapped to each of the plurality of band groups.

22. The method of claim 21, wherein the determining a different power density for each of the band groups according to characteristics of segment regions mapped to each of the plurality of band groups takes into account at least one of a size of segment regions mapped to each of the band groups, a bandwidth for each of the band groups, a load factor, a geographical condition, a channel condition, an interference condition, user distribution, a transmission scheme, and a data rate.

23. A system for controlling resource allocation in a multicell communication system including a plurality of cells, each of the cells using the same frequency band, the system comprising:
a controller for dividing a cell region for each of the cells into a plurality of segment regions, dividing the frequency band for each of the cells into a plurality of band groups, mapping corresponding segment regions to each of the band groups, and upon detecting user data targeting a plurality of mobile stations (MSs), allocating a band group through which the user data for each of the MSs will be transmitted, among the plurality of band groups;
a band group allocator for allocating a band group such that the user data for each of the MSs is transmitted through the corresponding band group;
a bandwidth allocator for allocating a bandwidth of the band group allocated for transmission of the user data for each of the MSs;
a load factor allocator for allocating a load factor of the band group allocated for transmission of the user data for each of the MSs;
a power allocator for allocating power of the band group allocated for transmission of the user data for each of the MSs; and
a radio frequency (RF) processor for RF-processing a signal of the power-allocated band group and transmitting the RF-processed signal.

24. The system of claim 23, wherein the controller maps the corresponding segment regions among the segment regions taking into account at least one of a size of segment regions mapped to each of the band groups, a position where an MS is located, a geographical condition, a channel condition, an interference condition, and user distribution.

25. The system of claim 23, wherein the controller maps the corresponding segment regions among the segment regions -taking into account at least one of a signal condition, an interference condition and user distribution between the same band groups in the segment regions mapped to the same band groups in neighbor cells.

26. The system of claim 23, wherein the controller divides a cell region for each of the cells into a plurality of segment regions taking into account at least one of a distance from the cell center, an antenna characteristic applied to each of the cells, a geographical condition for each of the cells, a channel condition and an interference condition for each of the cells, and user distribution condition for each of the cells.

27. The system of claim 26, wherein the antenna characteristic is determined taking into account at least one of a radiation pattern of a transceiver antenna, a location of a transmission/reception antenna, and a radiation angle.

28. The system of claim 26, wherein the channel condition is determined taking into account at least one of a signal level attenuation caused by a change in distance, a shadow effect, a fading effect, a multipath effect, and a Doppler effect, and the interference condition is determined taking into account at least one of user distribution of a corresponding cell, a user distribution of another cell, a signal-to-interference and noise ratio (SINR), and an outage rate.

29. The system of claim 23, wherein the controller divides the frequency band for each of the cells into a plurality of band groups such that segment regions mapped to the plurality of band groups are consecutive.

30. The system of claim 23, wherein the controller divides the frequency band for each of the cells into a plurality of band groups such that segment regions mapped to the plurality of band groups are non-consecutive.

31. The system of claim 23, wherein if the multicell communication system is a multi-carrier multicell communication system using a plurality of sub-carriers, the controller divides the frequency band for each of the cells into a plurality of band groups such that sub-carriers mapped to the plurality of band groups are consecutive.

32. The system of claim 23, wherein if the multicell communication system is a multi-carrier multicell communication system using a plurality of sub-carriers, the controller divides the frequency band for each of the cells into a plurality of band groups such that sub-carriers mapped to the plurality of band groups are non-consecutive.

33. The system of claim 23, wherein the controller divides the frequency band for each of the cells into a plurality of band groups having the same bandwidth.

34. The system of claim 23, wherein the controller divides the frequency band for each of the cells into a plurality of band groups having different bandwidths.

35. The system of claim 34, wherein the controller divides the frequency band for each of the cells into a plurality of band groups having different bandwidths according to characteristics of segment regions mapped to each of the plurality of band groups.

36. The system of claim 35, wherein the controller divides the frequency band for each of the cells into a plurality of band groups having the different bandwidths taking into account at least one of a size of segment regions mapped to each of the band groups, a load factor applied to each of the band groups, a power density, a geographical condition, a channel condition, an interference condition, user distribution, a transmission scheme, and a data rate.

37. The system of claim 23, wherein after dividing the frequency band for each of the cells into a plurality of band groups, the controller determines a load factor for each of the band groups.

38. The system of claim 37, wherein the controller determines a uniform load factor for each of the band groups.

39. The system of claim 37, wherein the controller determines a different load factor for each of the band groups according to characteristics of segment regions mapped to each of the plurality of band groups.

40. The system of claim 39, wherein the controller determines a different load factor for each of the band groups taking into account at least one of a size of segment regions mapped to each of the band groups, a bandwidth for each of the band groups, a power density, a geographical condition, a channel condition, an interference condition, user distribution, a transmission scheme, and a data rate.

41. The system of claim 23, wherein after dividing the frequency band for each of the cells into a plurality of band groups, the controller determines a power density for each of the band groups.

42. The system of claim 41, wherein the controller determines a uniform power density for each of the band groups.

43. The system of claim 41, wherein the controller determines a different power density for each of the band groups according to characteristics of segment regions mapped to each of the plurality of band groups.

44. The system of claim 43, wherein the controller determines a different power density for each of the band groups taking into account at least one of a size of segment regions mapped to each of the band groups, a bandwidth for each of the band groups, a load factor, a geographical condition, a channel condition, an interference condition, user distribution, a transmission scheme, and a data rate.
